(19) United States
(12) Patent Application Publication
(10) Pub. No.: US 2019/0302510 A1
(43) Pub. Date: Oct. 3, 2019

(54) PROTECTION DEVICE SUITABLE FOR CURVED-SURFACE SCREEN OF ELECTRONIC EQUIPMENT

(71) Applicant: Xiaohai ZHAO, SHANDONG PROVINCE (CN)

(72) Inventor: Xiaohai ZHAO, SHANDONG PROVINCE (CN)

(21) Appl. No.: 15/944,744

(22) Filed: Apr. 3, 2018

(51) Int. Cl. G02F 1/1333; G02F 1/1341; C08J 5/18

(52) U.S. Cl. CPC G02F 1/133305; G02F 1/1341; G02F 2001/133331; G02F 2001/133311; C08J 5/18

(57) ABSTRACT

The present invention relates to the field of a protection device for a curved-surface screen, in particular to a protection device suitable for a curved-surface screen of electronic equipment. The present invention provides two methods for preparing the curved-surface glass, one of which is non-hot-bending treatment, and the other is non-uniform thickness treatment of the glass before the hot-bending treatment, so that the prepared curved-surface tempered glass film and the screen of the electronic equipment can be completely attached by vacuum adsorption, thereby solving the problem of fragile screens.

### BACKGROUND OF THE INVENTION

The present invention relates to the field of a protection device for a curved-surface screen, in particular to a protection device suitable for a curved-surface screen of electronic equipment.

In the prior art, since the use of OLED liquid crystal display screens in electronic communication equipment, the surfaces of the equipment are extensively updated into curved-surface glass screens to greatly increase the space display effect. However, the traditional flat-surface tempered glass film cannot be applied to the curved-surface communication equipment, so that the curved-surface tempered glass protection devices, i.e. curved-surface tempered glass films, are successively produced.

The glass shaping of the existing curved-surface tempered glass film is used a hot-bending technology, an explosion-proof film is attached to the inner concave surface of the tempered glass, wherein the film attached to the concave surface is an explosion-proof film with anti-Newton ring arrangement lattice, and then in order to fix the tempered glass film to the glass on the surface of a mobile phone, a circle of double-sided adhesive tape is pasted on the edge of the explosion-proof film to protect the glass on the surface of the electronic equipment, wherein Newton ring means “a rainbow pattern generated when a smooth plane comes into contact with a smooth plane”. However, the curved-surface tempered glass film prepared using the above method has the following disadvantages:

1. Under the bi-directional conditions of the tolerance of the glass panel of the electronic equipment screen and the tolerance of the curved-surface tempered glass film, use of such curved-surface tempered glass film on the electronic equipment screen results in the bending portion being in a suspended state, thereby causing the problem of insensitive touch; and the tempered glass film cannot be tightly attached to or absorbed on the glass at the surface of the mobile phone, and is in a semi-contact and semi-suspended state.

2. Since all the currently used curved-tempered glass films use explosion-proof films with anti-Newton ring lattice, the visual effect is greatly influenced when such curved-surface tempered glass film is used on the electronic equipment screen. The lattice arrangement is obvious, which affects the display effect of the electronic equipment screen.

3. For the currently used curved-surface tempered glass film, a circle of double-sided adhesive tape is pasted on the edge of the film to fixedly adhere the glass film to the electronic equipment screen, so that the problems of dropping and falling off can be caused.

In the prior art, a small portion of curved-surface tempered glass films are directly subjected to hot bending by using flat-surface glass of less than 0.3 mm, and then a thick layer of AB glue is adhered to fill the tolerance. However, the curved-surface tempered glass film prepared using this method has the following disadvantages:

1. When in use, the curved-surface tempered glass film is very fragile and is easily broken;

2. The stability is very poor and cannot be tested, and the application rate is extremely low; and

3. The edge is not properly attached and may be warped, and the problems of white edges and air bubbles are serious, so that the protected electronic equipment screen therefrom cannot be used.

Therefore, the curved-surface tempered glass film prepared by the prior art and the electronic equipment screen cannot be completely attached by vacuum adsorption.

### BRIEF SUMMARY OF THE INVENTION

In order to solve the above problems, the present invention provides a protection device suitable for a curved-surface screen of electronic equipment, which can ensure that a curved-surface tempered glass film and an electronic equipment screen are completely attached by vacuum adsorption without the problems of warping and white edges, ensure the normal use of the electronic equipment screen, and avoid the problems of insensitive touch, influence on the display effect, easy falling off, and the like at the same time, thereby strongly guaranteeing the prevention of the problem of a fragile electronic equipment screen with a curved-surface liquid crystal screen.

To achieve the above object, the present invention adopts the following technical solution: a protection device suitable for a curved-surface screen of electronic equipment, the preparation steps thereof are as follows:

S1. Slicing of the glass: slicing the glass into the size of a corresponding electronic equipment screen, treating the front side of the glass into a concave surface, and then treating the edge of the back side thereof into a fillet, to form the curved-surface glass;

S2. Double-sided polishing: polishing the surface of the curved-surface glass using a polishing machine;

S3. Cleaning and tempering: performing double-sided cleaning on the curved-surface glass using an ultrasonic machine, and placing the curved-surface glass in a glass tempering furnace for tempering, to obtain the curved-surface tempered glass;

S4. Printing: selecting whether to print color in corresponding positions of the frame of the curved-surface tempered glass according to the non-display region of the electronic equipment screen, and then performing the ultrasonic cleaning again; and

S5. Attaching: attaching AB glue to the front side of the curved-surface tempered glass using an attaching machine, and electroplating fingerprint proof oil on the back side thereof, to obtain a curved-surface tempered glass film.

Further, in the S1, the middle of the front side of the glass is treated into a concave shape using a digital controlled lathe or a CNC engraving and milling machine or a chemical substance to form a concave surface, and then the edge of the back side of the glass is treated into a fillet using the CNC engraving and milling machine, wherein the concave surface is engraved and milled into a curved-surface shape using the CNC engraving and milling machine to obtain the curved-surface glass with non-uniform thickness, the thickness being adapted to the tolerance of the surface bending of the electronic equipment screen.

Further, there is another method for obtaining the curved-surface glass. In the S1, according to the corresponding tolerance of the surface bending of electronic equipment screen, different thickness treatments are performed on the front side of the glass using the CNC engraving and milling machine according to the tolerance, the edge of the back side is filleted, and then the double-sided polishing is performed, wherein after double-sided polishing, hot-bending treatment is performed to obtain the concave-surface glass with non-uniform thickness, the thickness being adapted to the tolerance of the surface bending of electronic equipment screen.

Further, the used glass has a thickness of greater than or equal to 0.1 mm, and the fillet has a thickness of 0.1 to 30 mm.

Further, in the S1, the concave surface includes an intermediate flat portion and a peripheral curved-surface portion, wherein the thickness of the flat portion is different from that of the curved-surface portion, or the curved-surface portion exhibits different thickness.

The present invention has the beneficial effect that: the present invention provides two methods for preparing curved-surface glass, one of which is non-hot-bending treatment, and the other is non-uniform thickness treatment of the glass before the hot-bending treatment, so that the prepared curved-surface tempered glass film and the screen of the electronic equipment can be completely attached by vacuum adsorption, presents a clear display effect, the curved-surface liquid crystal display screen of the electronic equipment can be protected at 360 degrees without dead angle, thereby solving the problem of fragile screens.

In addition, the curved-surface tempered glass film of the present invention may not cause the problems of falling off and attaching rebound bubbles and does not have the phenomenon of improper attachment or warping, thereby ensuring the normal use of the electronic equipment screen. The present invention is suitable for any electronic equipment with curved-surface liquid crystal display screen, such as mobile phone, tablet computer, watch, game machine, computer, and the like.

### BRIEF DESCRIPTION OF THE DRAWINGS

FIG. 1 is a flow block diagram of the present invention.

### DETAILED DESCRIPTION OF THE INVENTION

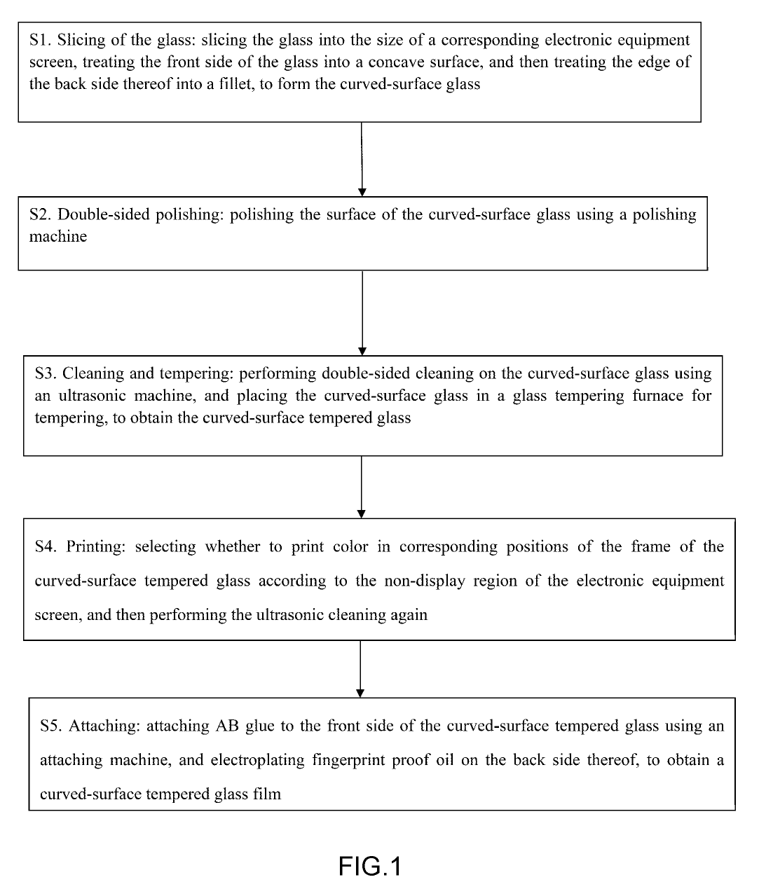

Referring to FIG. 1, the present invention relates to a protection device suitable for a curved-surface screen of electronic equipment, the preparation steps thereof are as follows:

S1: Slicing of the glass: there are two methods for preparing curved-surface glass, wherein the first method includes: using glass with a thickness of more than 0.1 mm, slicing the glass into the size of a corresponding electronic equipment screen, treating the middle of the front side of the glass into a concave shape using a digital controlled lathe or a CNC engraving and milling machine or a chemical substance to form a concave surface, and then treating the edge of the back side of the glass into a fillet of 0.1 to 30 mm using the CNC engraving and milling machine, and engraving and milling the concave surface into a curved-surface shape using the CNC engraving and milling machine to obtain curved-surface glass with non-uniform thickness; and

the second method includes: using the glass with a thickness of more than 0.1 to 5 mm, according to the tolerance of surface bending of the corresponding electronic equipment screen, treating the front side of the glass into different thickness using the CNC engraving and milling machine according to the tolerance, treating the edge of the back side into a fillet of 0.1 to 30 mm, and then performing double-sided polishing, to obtain a curved-surface glass with the curve thickness distributed in a non-uniform wave form through hot-bending treatment;

wherein the concave surface includes an intermediate flat portion and a peripheral curved-surface portion, wherein the thickness of the flat portion is smaller than that of the curved-surface portion, the whole curved-surface glass exhibits non-uniform thickness, and the thickness varies according to the surface tolerance of the electronic equipment screen.

S2. Double-sided polishing: polishing the surface of the curved-surface glass for 10 minutes using a polishing machine, wherein the polishing material used is bristles;

S3. Cleaning and tempering: performing double-sided cleaning on the curved-surface glass using an ultrasonic machine, and placing the curved-surface glass in a glass tempering furnace for tempering, to obtain curved-surface tempered glass;

S4. Printing: selecting whether to print color in corresponding positions of the frame of the curved-surface tempered glass according to the non-display region of the electronic equipment screen, and then performing the ultrasonic cleaning again using the ultrasonic machine after printing; and

S5. Attaching: attaching AB glue to the front side of the curved-surface tempered glass using an attaching machine, and electroplating fingerprint proof oil on the back side thereof, to obtain a curved-surface tempered glass film.

Compared with the prior art, the present invention provides two methods for preparing curved-surface glass, one of which is non-hot-bending treatment, and the other is non-uniform thickness treatment of the glass before hot-bending treatment, so that the prepared curved-surface tempered glass film and the electronic equipment screen can be completely attached by vacuum adsorption, presents a clear display effect, and the curved-surface liquid crystal display screen of the electronic equipment can be protected at 360 degrees without dead angle, thereby solving the problem of fragile screens. In addition, the curved-surface tempered glass film of the present invention may not cause the problems of falling off and attaching rebound bubbles and does not have the phenomenon of improper attachment or warping, thereby ensuring the normal use of the electronic equipment screen. The present invention is suitable for any electronic equipment with curved-surface liquid crystal display screen, such as mobile phone, tablet computer, watch, game machine, computer, and the like The curved-surface tempered glass film of the present invention may be reused, and tempered glass used can also be reused, thereby achieving the purpose of environmental protection.

In this specific embodiment, the AB glue uses a thin film with any thickness as a substrate, Acrylic glue or OCA glue is applied onto one side thereof, and silica glue is applied onto the other side thereof, the side onto which Acrylic glue or OCA glue is applied is called side A, and the side onto which the silica glue is applied is called side B. Side A is permanently tightly attached to the concave surface of the curved-surface tempered glass to form a complete curved-surface tempered glass film, and the curved-surface tempered glass film is attached to the corresponding curved-surface display screen of the electronic equipment by vacuum adsorption by the side B. Wherein, Side B of the AB glue may be attached to any panel manufactured according to the tolerance data of the curved-surface screen of the electronic equipment in advance, and the panel may be leveled in advance using any material with smooth surface. In this way, the curved-surface tempered glass film and the corresponding curved-surface screen of the electronic equipment can be rapidly vented and attached by vacuum adsorption more conveniently.

Compared with the prior art, when the curved-surface glass is prepared, there is a need to redesign the data of the concave surface of the glass, the thickness of the flat portion in the middle of the concave surface of the curved-surface glass must be less than that of the curved-surface bending portion, and the thickness needs to correspond to each other according to the radian from the flat portion in the middle of the glass panel on the surface the corresponding electronic equipment screen to the bending portion. The present invention is a tempered glass film with random curved-surface shape except flat surface. For the curved-surface tempered glass film of the present invention, it can be clearly seen that the curved-surface tempered glass film has thickness difference in glass thickness thereof within normal eye vision range.

As a preferred mode of this specific embodiment, the closer the flat portion of the curved-surface glass to the bending portion is, the more different the thickness is, to achieve radian consistency and tightness when the convex surface of the electronic equipment screen and the concave surface of the curved-surface tempered glass are attached by vacuum adsorption. Since when the AB glue is attached to the concave surface of the curved-surface tempered glass, the whole flat AB glue is attached according to the shape of the concave surface of the curved-surface glass, and then corresponding thickness is generated. Therefore, the thickness from the flat portion of the inner concave surface of the curved-surface glass to the bending portion must vary according to the thickness of the filled AB glue and the tolerance. Moreover, the tolerance of the curved-surface tempered glass thereof and the tolerance of the screen of the electronic equipment with a curved-surface liquid display screen required are taken into account. In combination with the thickness of the AB glue used above, by the non-uniform thickness of the curved-surface tempered glass film regulated, the curved-surface tempered glass film and the electronic equipment screen can be completely attached by vacuum adsorption.

In this specific embodiment, through countless tests on the vacuum adsorption performance between the curved-surface tempered glass film and the curved-surface screen of the electronic equipment and data modification and introduction of related usage equipment at the same time, it is proved that this curved-surface tempered glass film is suitable for any electronic equipment with a curved-surface liquid crystal display screen to protect the fragile curved-surface liquid crystal screen of the electronic equipment at 360 degrees without dead angle, and have no influence on any use; the problem that the curved-surface tempered glass film and the electronic equipment with a curved-surface liquid crystal display screen cannot be attached by vacuum adsorption for a long time is solved, and the problems of insensitive touch, influence on the display effect, easy falling off, and the like are avoided, thereby strongly guaranteeing the prevention of the problem of fragile screens of electronic equipment with curved-surface liquid crystal screens.

This specific embodiment completely solves the problem of vacuum adsorption and protection of the original curved-surface tempered glass film and any electronic equipment with a curved-surface display screen, solves the problem of insensitive touch of the original curved-surface tempered glass film first, solves the problem of visual effect influenced by lattice arrangement at the same time, solves the problem of falling off, and also solves the problem of instability of matching degree between the curved-surface tempered glass film filled by too thick AB glue and the electronic equipment with a liquid crystal display screen. Through our countless tests, the results prove that the present invention may completely and seamlessly adsorb by vacuum a corresponding curved-surface tempered glass film onto the surface of the display screen of the electronic equipment, and has no effect on the use of the equipment and fully protects the same.

This specific embodiment is suitable for any electronic equipment with a curved-surface liquid crystal display screen. In the usage method, positioning may be performed using a precise alignment device or positioning device, venting may be rapidly performed using any roller, scraping card or hand push as well, and the used silica glue may be adsorbed by vacuum or may be adsorbed automatically. In this specific embodiment, the curved-surface tempered glass may be reused, and the used tempered glass may be reused, thereby being economic and environmentally-friendly.

The above embodiments are merely the descriptions of the preferred embodiments of the present invention but are not intended to limit the scope of the present invention. Without departing from the design spirit of the present invention, those of ordinary skill in the art can make various modifications and improvements to the technical solutions of the present invention, all of which shall fall within the protection scope defined by the appended claims of the present invention.

What is claimed is:

1. A protection device suitable for a curved-surface screen of electronic equipment, characterized in that it comprises the following preparation steps:
S1. Slicing of the glass: slicing the glass into the size of a corresponding electronic equipment screen, treating the front side of the glass into a concave surface, and then treating the edge of the back side thereof into a fillet, to form the curved-surface glass;
S2. Double-sided polishing: polishing the surface of the curved-surface glass using a polishing machine;
S3. Cleaning and tempering: performing double-sided cleaning on the curved-surface glass using an ultrasonic machine, and placing the curved-surface glass in a glass tempering furnace for tempering, to obtain the curved-surface tempered glass;
S4. Printing: selecting whether to print color in corresponding positions of the frame of the curved-surface tempered glass according to the non-display region of the electronic equipment screen, and then performing the ultrasonic cleaning again; and
S5. Attaching: attaching AB glue to the front side of the curved-surface tempered glass using an attaching machine, and electroplating fingerprint proof oil on the back side thereof, to obtain a curved-surface tempered glass film.

2. The protection device suitable for a curved-surface screen of electronic equipment according to claim 1, characterized in that in the S1, the middle of the front side of the glass is treated into a concave shape using a digital controlled lathe or a CNC engraving and milling machine or a chemical substance to form a concave surface, and then the edge of the back side of the glass is treated into a fillet using the CNC engraving and milling machine.

3. The protection device suitable for a curved-surface screen of electronic equipment according to claim 2, characterized in that the concave surface is engraved and milled into a curved-surface shape using the CNC engraving and milling machine to obtain the curved-surface glass with non-uniform thickness, the thickness being adapted to the tolerance of the surface bending of the electronic equipment screen.

4. The protection device suitable for a curved-surface screen of electronic equipment according to claim 1, characterized in that in the S1, according to the corresponding tolerance of the surface bending of electronic equipment screen, different thickness treatments are performed on the front side of the glass using the CNC engraving and milling machine according to the tolerance, the edge of the back side is filleted, and then the double-sided polishing is performed.

5. The protection device suitable for a curved-surface screen of electronic equipment according to claim 4, characterized in that after double-sided polishing, hot-bending treatment is performed to obtain the concave-surface glass with non-uniform thickness, the thickness being adapted to the tolerance of the surface bending of electronic equipment screen.

6. The protection device suitable for a curved-surface screen of electronic equipment according to claim 2 or 4, characterized in that the used glass has a thickness of greater than or equal to 0.1 mm, and the fillet has a thickness of 0.1 to 30 mm.

7. The protection device suitable for a curved-surface screen of electronic equipment according to claim 1, characterized in that in the S1, the concave surface includes an intermediate flat portion and a peripheral curved-surface portion, wherein the thickness of the flat portion is different from that of the curved-surface portion, or the curved-surface portion exhibits different thickness.
